(19) United States
(12) Patent Application Publication
(10) Pub. No.: US 2010/0141810 A1
(43) Pub. Date: Jun. 10, 2010

(54) Bad Pixel Detection and Correction

(75) Inventors: LinCheng Wang, San Jose, CA (US); ChengLun Chang, San Jose, CA (US); Song Xue, San Jose, CA (US)

Correspondence Address: FERNANDEZ & ASSOCIATES, LLP, P.O. BOX D, MENLO PARK, CA, 94026, US

(73) Assignee: ProImage Technology, San Jose, CA (US)

(21) Appl. No.: 12/328,138

(22) Filed: Dec. 4, 2008

(51) Int. Cl. H04N 9/64

(52) U.S. Cl. 348/246

(57) ABSTRACT

The invention relates to a method for bad pixel classification for an image sensor having a plurality of sensing elements. The method includes capturing a plurality of images using the image sensor, determining based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value, tallying the vote to generate a voting count by performing iterations of the determining step using different images of the plurality of images and different threshold values of the one or more pre-determined threshold values, and classifying the sensing element as a bad pixel if the voting count exceeds a pre-determined classification threshold.

### BACKGROUND

Electronic image sensing devices, such as CCD and CMOS image sensors, are typically configured with a matrix of sensing elements for capturing light input to produce images made up by rows and columns of image pixels. The process of sensing light input to produce images or image pixels are often referred to as capturing the images or capturing the image pixels. Here, the terms “image” and “image pixel” refer to digital representation of the physical image and element of the physical image. Each image pixel has pixel values representing the sensed light input. Pixel values can represent monochrome or color intensity in varying resolutions (e.g., 8 bit, 12 bit, etc). Each image pixel in an image is uniquely identified by its row/column (or x/y) location in the image and is associated with a corresponding sensing element in the image sensor by which the image pixel is captured. Image pixels at the same location in different images captured using the same image sensor are associated in the sense that they are captured by the same sensing element in the image sensor. The term “pixel” may be though of as purely a row/column (or y/x) location, therefore in various contexts, the term “pixel” may refer to an image pixel in an image, a sensing element in the image sensor used to capture the image pixel, or multiple image pixels as a group at the same location in different images captured by the same sensing element. In addition, depending on the context, the term “pixel” may also refer to an element in a display device for reproducing the physical image from the digital representation or a corresponding light element of the reproduced physical image. Furthermore, in addition to referring to the digital representation of the physical image, the term “image” may also refer to the physical image itself or the reproduced physical image depending on the context. Those skilled in the art will recognize the proper meaning of the terms “pixel” and “image” based on the context in the following description.

It is inevitable that electronic image sensing devices, as described above, contain a number of bad pixels caused, for example, by defective photo-detectors. Bad pixels cannot respond correctly to light intensity and appear as image artifacts. There are three common types of bad pixels—stuck-low, stuck-high, and abnormal sensitivity. A stuck-low pixel always has a low reading and appears darker in the generated image. In contrast, a stuck-high pixel always has a high reading and appears brighter in the generated image. An abnormal sensitivity pixel does not produce absolute low or high read out, as stuck-low or stuck-high pixels, but produces a variety of readings depending on intensity from its neighboring pixels. Other types of bad pixels may also exist in image sensors due to other failure mechanisms.

Typically, bad pixel correction methods use gradient operators to process an image. One method known in the art compares the test pixel and its neighboring pixels to determine whether the test pixel is a bad pixel. If the intensity value of the test pixel is greater than the maximum of its neighboring pixels, the test pixel is classified as bad pixel and the intensity value of the test pixel is replaced by the maximum of its neighboring pixels. If the intensity value of the test pixel is less than the minimum of its neighboring pixels, the test pixel is classified as bad pixel and the intensity value of the test pixel is replaced by the minimum of its neighboring pixels. Other methods known in the art uses the gradients of neighboring pixels not only in the same color plane, but also neighboring pixels in other color planes. Various known methods detect and correct bad pixels on the fly. Some memory, called line buffers, is needed to keep the neighboring pixels above and below the text pixel for detection and correction.

The use of the gradients of neighboring pixels in a single image for bad pixel detection and correction may generate false alarms or miss a bad pixel in a high quality image sensor. In the case of an image with single bright spot in dark background or a single dark spot in bright background, the intensity values of these singular pixels are out of the range of their neighboring pixels and can be incorrectly classified as outliers and cause false alarms. In the case of an image with fine checkerboard pattern, a bad pixel with intensity value in the range of its neighboring pixels can be incorrectly classified as functional one and cause a miss.

### SUMMARY

In general, in one aspect, the invention relates to a method for bad pixel classification for an image sensor having a plurality of sensing elements. The method includes capturing a plurality of images using the image sensor, determining based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value, tallying the vote to generate a voting count by performing iterations of the determining step using different images of the plurality of images and different threshold values of the one or more pre-determined threshold values, and classifying the sensing element as a bad pixel if the voting count exceeds a pre-determined classification threshold.

In general, in one aspect, the invention relates to a device for performing bad pixel classification for an image sensor having a plurality of sensing elements. The device includes a voting module configured to receive a plurality of images captured using the image sensor, determine based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value, tally the vote to generate a voting count by performing iterations of the determining step using different images of the plurality of images and different threshold values of the one or more pre-determined threshold values, and classify the sensing element as a bad pixel if the voting count exceeds a pre-determined classification threshold; and a classification module operatively coupled to the voting module and configured to compare the voting count to a pre-determined classification threshold, and classify the sensing element as a bad pixel if the voting count exceeds the pre-determined classification threshold.

In general, in one aspect, the invention relates to a system including an image sensor having a plurality of sensing elements, a voting module configured to receive a plurality of images captured using the image sensor, determine based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value, tally the vote to generate a voting count by performing iterations of the determining step using different images of the plurality of images and different threshold values of the one or more pre-determined threshold values, and classify the sensing element as a bad pixel if the voting count exceeds a pre-determined classification threshold; and a classification module operatively coupled to the voting module and configured to compare the voting count to a pre-determined classification threshold, and classify the sensing element as defective if the voting count exceeds the pre-determined classification threshold.

In general, in one aspect, the invention relates to a computer readable medium, embodying instructions executable by the computer to perform bad pixel classification for an image sensor having a plurality of sensing elements. The instructions comprising functionality for capturing a plurality of images using the image sensor, determining, using an image of the plurality of images and a threshold value selected from one or more pre-determined threshold values, whether a sensing element in the image sensor is defective, based on a pre-determined criterion, to generate a vote, wherein a threshold parameter associated with the pre-determined criterion is set to the threshold value, tallying the vote to generate a voting count by performing iterations of the determining step using different images of the plurality of images and different threshold values of the one or more pre-determined threshold values, and classifying the sensing element as a bad pixel if the voting count exceeds a pre-determined classification threshold.

Other aspects and advantages of the invention will be apparent from the following description and the appended claims.

### BRIEF DESCRIPTION OF DRAWINGS

FIGS. 1A and 1B show example schematic block diagrams of neighboring pixels in an image or an electronic image sensor using either or both of which embodiments of the invention can be implemented.

FIGS. 2-5 show example schematic system block diagrams according to aspects of the invention.

FIGS. 6-7 show example method flow charts according to aspects of the invention.

FIG. 8 shows example computer readable medium according to aspects of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. In other instances, well-known features have not been described in detail to avoid obscuring the invention.

Generally speaking, the present invention utilizes the pixel information in multiple images to perform bad pixel detection. The inter-image statistics is analyzed in detecting bad pixels to produce robust classification outcome. In one or more embodiments of the invention, the multiple images may be captured from varying scenes without meeting pre-determined specification such as those used in factory test environment. In one or more embodiments of the invention, the analysis of the multiple images can be performed to produce robust classification outcome without relying on complicated pixel level detection algorithm. In one or more embodiments of the invention, a camera system may be configured to perform real-time bad pixel detection and correction automatically in-between user directed image capturing sessions. As a result, bad pixels developed in time can be detected and corrected throughout the service life of the camera with minimum user intervention.

A bad pixel causes a lighter or darker spot at the same location in a sequence of images. It can be obvious for human eyes to find the bad pixels visually. However, it is not straightforward for machine intelligence to detect these bad pixels in a sequence of images without exploring the statistics of pixel information among images. One major limitation for a camera system to explore inter-image statistic in detecting bad pixels is the requirement of a frame buffer to store image pixels of multiple images. In one or more embodiments of the invention, a camera system may be configured with bad pixel detection and correction capability by analyzing the statistics of multiple images with no requirement of a frame buffer.

The performance of a bad pixel detection method may be evaluated based on sensitivity and specificity. Some pixels are defective, and the detector says they are defective. They are called true positives (TP) or hits. Some pixels are defective, but the detector is not able to say yes. They are called false negatives (FN) or misses. Some pixels are functional, and the detector says they are defective. They are called false positives (FP) or false alarms. Some pixels are functional, and the detector says no. They are called true negatives (TN) or correct rejections. The sum of TP, FN, FP, and TN makes up the total number of classified pixels. The sensitivity is defined as true positive rate (TPR) and the specificity is defined as true negative rate (TNR). Another important metric is false positive rate (FPR), which is 1—specificity. The calculation of TPR, TNR, and FPR is shown below.

$$sensitivity = TPR = \frac{TP}{P} = \frac{TP}{TP + FN}$$

$$specificity = TNR = \frac{TN}{N} = \frac{TN}{FP + TN}$$

$$1 \text{-} specificity = FPR = \frac{FP}{N} = \frac{FP}{FP + TN}$$

In general, conventional bad pixel detection methods suffer from the inter-dependency of TPR and FPR. That is, a high TPR comes with high FPR, while a low FPR yields a low TPR. The goal of designing a bad pixel detection method is to achieve high true positive rate (TPR), meanwhile keeping a low false positive rate (FPR).

In one or more embodiments of the invention, the bad pixel detection may be modeled as a binary classifier system, which classifies each pixel in an image into two groups, functional and bad (defective), on the basis of observable evidence. The evidence may be based on the neighboring pixels of the classified pixel (i.e., the test pixel). In one or more embodiments of the invention, the bad pixel detection and correction methods may use gradient operators on neighboring pixels of the test pixel and apply thresholds to the calculated values of the gradient operators to determine whether the test pixel is defective or not.

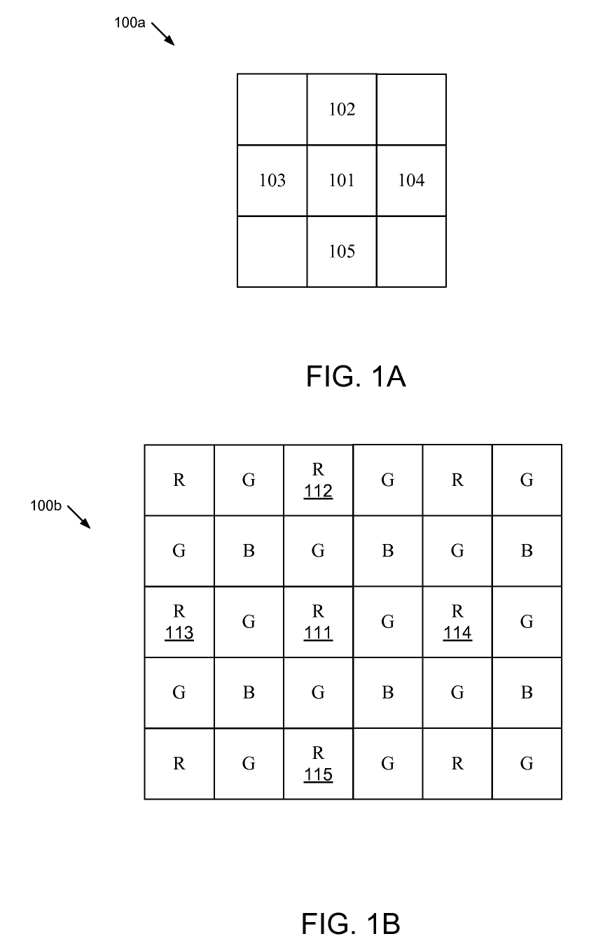

FIG. 1A shows an example schematic block diagram of neighboring pixels (100a) in a portion of a monochrome image or a monochrome electronic image sensor. As shown in FIG. 1A, a test pixel (101) has four nearest neighbor pixels (102)-(105) within the image. Each of the pixels (101)-(105) corresponds to a sensing element in the image sensor. As described above, the pixels (101)-(105) may refer to pixels in multiple images. The test pixel (101) and its neighboring pixels (102)-(105) may have pixel values P, A, B, C, and D, respectively.

FIG. 1B shows an example schematic block diagram of neighboring pixels (100b) in portion of a color image or a color electronic image sensor. As shown in FIG. 1B, red, green, and blue color pixels, denoted as R, G, and B, respectively, are arranged in a Bayer pattern to form the image or the image sensor. The image or image sensor is said to include a red, green, and blue color plane made up by all red, green, and blue pixels, respectively. Considering the red plane of an image, a test pixel (111) has four nearest neighbor pixels (112)-(115) in the red plane. Each of the pixels (111)-(115) corresponds to a sensing element in the red plane of an image sensor. As described above, the pixels (111)-(115) may refer to pixels in multiple images. The test pixel (111) and its neighboring pixels (112)-(115) may have pixel values P, A, B, C, and D, respectively. Although the layout of the color pixels is based on the Bayer pattern in the example above, one skilled in the art will recognize, with the benefit of this disclosure, that other patterns may also be used without deviating from the spirit of the invention.

In one or more embodiments of the invention, a simple gradient operator may be used to test all the pixels of multiple images using a voting threshold with a selected value. For example, the test pixel and its neighboring pixels may have pixel values in a color plane as P, A, B, C, and D, respectively. The simple gradient operator classifies the test pixel (thus the corresponding sensing element) to be bad (defective), if all of four absolute differences between P and P, A, B, C, and D, respectively, are greater than a given voting threshold value T, which is one of {T₁, T₂, . . . , T_{M}}. Otherwise, the sensing element corresponding to the test pixel is classified to be functional. In this example, the gradient operator may be formulated as

(|P−A|>T)AND(|P−B|>T)AND(|P−C|>T)AND(|P−D|>T)

Due to the possibility of false detection, the test pixel (thus the corresponding sensing element) classified as defective above may not be a true bad pixel. Therefore, a pixel (thus the corresponding sensing element) classified as defective is referred to as a bad pixel candidate until it is voted into a bad pixel as described below.

In one or more embodiments of the invention, multiple images may be used in conjunction with the set of voting threshold values {T₁, T₂, . . . , T_{M}} to optimize the sensitivity (TPR), specificity (TNR), and false positive rate (FPR). For example, the set of voting threshold values {T₁, T₂, . . . . , T_{M}} may be selected from values ranging from the maximum pixel value (e.g., 256 for 8-bit resolution, 4096 for 12-bit resolution, etc) down to a minimum threshold value. In one or more embodiments of the invention, the set of voting threshold values {T₁, T₂, . . . , T_{M}} may be selected by dividing the range by (M−1) resulting in equal divisions. In one or more embodiments of the invention, the number of voting threshold values and the minimum threshold value may be adjusted to maximize FPR.

Multiple images present a variety of scenes, luminance intensities, fields of views, etc. In one or more embodiments of the invention, a number of classification outcomes (i.e., text pixel being defective or not) are obtained for each pixel (sensing element) by applying a simple gradient operator on multiple images. For example, if N images are used for the process of bad pixel detection, N classification outcomes are obtained for each pixel (sensing element). In one or more embodiments of the invention, these N classification outcomes form a committee of classifiers to vote and determine whether this pixel (sensing element) is a bad pixel or not. Different voting schemes may be employed to allow determination of the pixel (sensing element) being defective by one or more individual classifiers be voted into determination of the pixel (sensing element) being a bad pixel. Said in other words, the bad pixel candidate is voted into the bad pixel according to the voting scheme.

Generally speaking, a necessary and sufficient condition for a committee of classifiers to be more accurate than any of its individual member classifier is that the classifiers are accurate and diverse. An accurate classifier is the one that has an error rate better than random guessing on a pixel. A simple gradient operator described with respect to FIG. 1 can do this job well. Classifiers in a committee are diverse if they make a variety of classification outcomes on a pixel (sensing element). For example, some bad pixels may be undetectable in some images, but are detectable in most of images. Some functional pixels may be misclassified to be bad pixels in a few images, but can be correctly classified in most of images. A committee of classifiers can generally result in more accurate performance. One advantage of the present invention is that it is not necessary to use a complicated bad pixel detection algorithm at the pixel level. The pixel information in multiple images is sufficient to give a robust statistical outcome.

In one or more embodiments of the invention, a weighted voting scheme may be used within the committee of classifiers in determining whether a pixel (sensing element) is defective or not. For example, each image analyzed based on gradient operators using one of a set of pre-determined voting threshold values may count as one classifier of the committee. Therefore, N images analyzed using M thresholds may form a committee of M×N committee member classifiers to classify the pixel (sensing element) based on a weighting scheme. In one or more embodiments of the invention, the vote of each classifier may be weighted based on the image or the threshold according a pre-determined weighting scheme. For example, classification outcomes using different images may be weighted differently in a voting scheme where the weighting is based on an attribute (e.g., associated with the scene, luminance intensity, field of view, etc.) of the image. Similarly, classification outcomes using different threshold values may be weighted differently in a voting scheme favoring certain threshold values. The examples described below treat each classifier equally and set equal weight for each classifier for clarity.

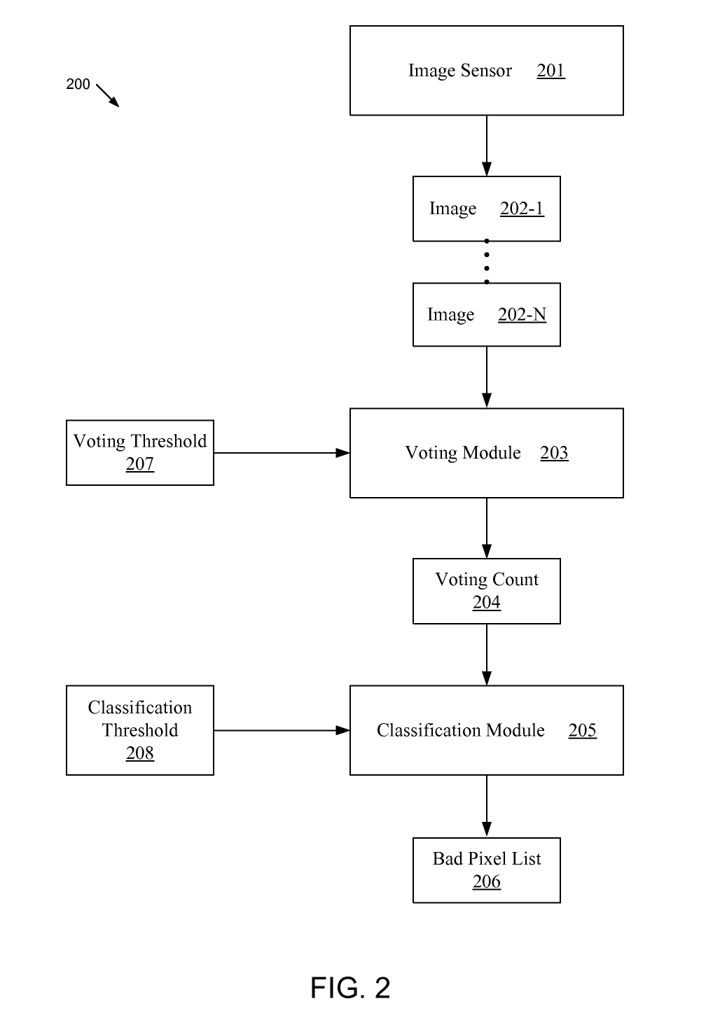

FIG. 2 shows a system block diagram of a system (200) for bad pixel detection according to aspects of the invention. Here, system (200) includes image sensor (201), voting module (203), and classification module (205). In one or more embodiments of the invention, the input to the voting module (203) is a set of threshold values {T₁, T₂, . . . , T_{M}} of voting threshold (207) and a set of images (202-1) through (202-N) captured using the image sensor (210) where and N≧1. The voting threshold (207) is used by a pre-determined criterion (e.g., the simple gradient operator described with respect to FIG. 1 above) for pixel level bad pixel candidate determination. Accordingly, M×N classifiers form the committee to vote for each pixel (sensing element) where each classifier corresponds to one of the N images using one of the M voting threshold values. The output of the voting module (203) is the voting counts (204) {V₁, V₂, . . . , V_{L}} of all pixels (sensing elements) in the image sensor (201), where L is the image size (calculated by the multiplication of image width W and height H). The input to the classification module (204) is the voting counts (204) {V₁, V₂, . . . , V_{L}} of all pixels (sensing elements) and a threshold value of classification threshold (208). The output of the classification module (205) is a list of K bad pixels {S₁, S₂, . . . , S_{K}}, forming bad pixel list (206).

Different values of threshold from the voting threshold (207) used in the gradient operator described above result in different detection rate of bad pixel candidates by the voting module (203). For example, a high value of threshold may result in a lower detection rate of bad pixel candidates, while a low value of threshold may result in a higher detection rate of bad pixel candidates. In one or more embodiments of the invention, the set of threshold values {T₁, T₂, . . . , T_{M}} may be selected by dividing a portion of the total range of pixel values (e.g., 256 values for 8 bit resolution, 4096 values for 12 bit resolution, etc.) equally. In one or more embodiments of the invention, the set of threshold values {T₁, T₂, . . . , T_{M}} is sorted; that is, T₁>T₂> . . . , T_{M} while the M×N classifiers are applied according to the sorted sequence such that the threshold values are progressively decreased to vote progressively higher number of pixels as defective. In one or more embodiments of the invention, the classification process (i.e., the voting process) may be performed until the minimum threshold value T₁ is reached. In one or more embodiments of the invention, the classification process may be terminated before the minimum threshold value T₁ is reached if a pre-determined condition is met, for example, when the rate of accumulating incremental votes from advancing in the ordered sequence stabilizes or when a maximum number of allowable defective pixels (i.e., bad pixel candidates) is reached, in which case the image sensor may be declared unacceptable.

In one or more embodiments of the invention, the set of images (202-1) through (202-N) may be captured using the image sensor (210) automatically without user (not shown) intervention in-between user directed image capture. For example, system (200) may be part of a still image camera or a video camera within which the set of images (202-1) through (202-N) may be captured using the image sensor (210) during power-on initialization phase of the camera or in-between picture taking/video recording directed by the user. The images (202-1) through (202-N) may be captured from any scenes the camera is pointed toward at the time.

In one or more embodiments of the invention, the voting count (204) {V₁, V₂, . . . , V_{L}} may be stored in a voting count table that includes one entry for each pixel (sensing element) i of the image sensor (201) for storing the corresponding voting count Vᵢ where 1<i<L. For example, the voting count table may be implemented using a non-volatile memory or other suitable data repository.

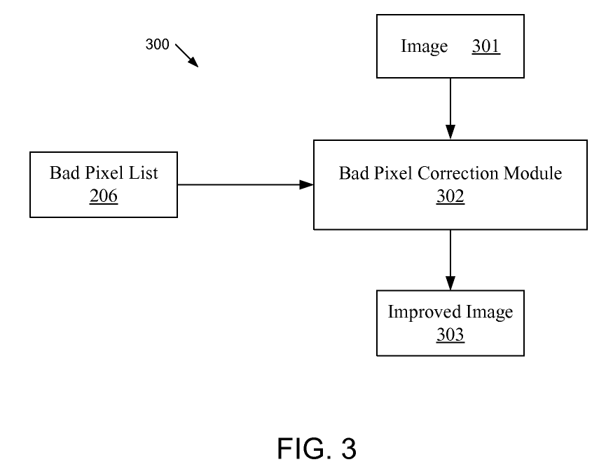

FIG. 3 shows a system block diagram of a system (300) for bad pixel correction according to aspects of the invention. Here, system (300) includes bad pixel correction module (302) that receives image (301) (e.g., from the image sensor (201) of FIG. 2) to produce improved image (303) using the bad pixel list (206), for example including bad pixels {S₁, S₂, . . . , S_{K}}. In one or more embodiments of the invention, a pixel at location (y,x) in the image (301) may be corrected using conventional method if it corresponds to any of {S₁, S₂, . . . S_{K}} in the bad pixels pixel list (206). The conventional method is executed for every pixel of the image (301); that is, it is repeatedly executed for W×H times, where H is the image height and W is the image width. At the end of bad pixel correction process, an improved bad-pixel-free image (303) is obtained.

In one or more embodiments of the invention, the image (301) may be captured using the image sensor (210) as directed by a user. For example, system (300) may be part of a still image camera or a video camera within which the image (301) may be captured using the image sensor (210) during picture taking/video recording directed by the user.

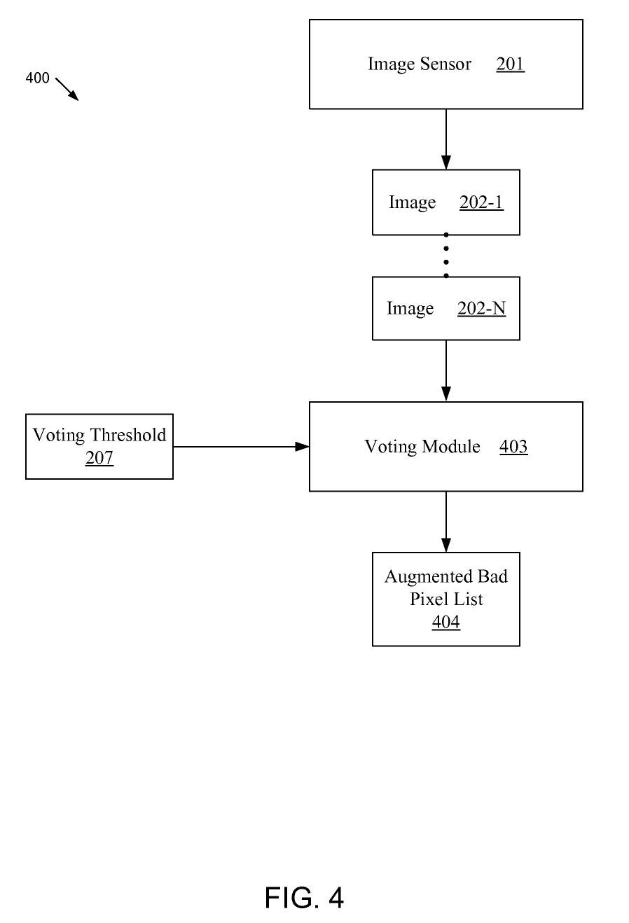

FIG. 4 shows a system block diagram of a system (400) for bad pixel detection according to aspects of the invention. Here, system (400) includes image sensor (201) and voting module (403). In one or more embodiments of the invention, the input to the voting module (403) is the set of threshold values {T₁, T₂, . . . , T_{M}} of voting threshold (207) and a set of images (202-1) through (202-N) captured using the image sensor (210) where M≧1 and N≧1. In the same manner as described with respect to FIG. 2 above, M×N classifiers form the committee to vote for each pixel (sensing element) where each classifier corresponds to one of the N images using one of the M threshold values. The output of the voting module (403) is the augmented bad pixel list (404) {U₁, U₂, . . . , U_{K}}, where K is a number of pixels (sensing elements) voted as defective by at least one of the classifiers. The data structure of an entry in the augmented bad pixel list includes both the location and the voting count of a defective pixel (sensing element). Typically, the memory requirement in system (400) is reduced by only storing information of defective pixels (sensing elements) instead of storing voting count for each pixel (sensing element) in the image sensor (201), as is the case for system (200). In one or more embodiments of the invention, system (400) may be part of a camera system that has a limited memory capacity.

In one or more embodiments of the invention, the classification process (i.e., the voting process) may be performed until the minimum threshold value T₁ is reached, in which case the augmented bad pixel list is configured as a variable size data structure including one entry for each of the K pixels voted as defective where K may be a variable number. In one or more embodiments of the invention, the classification process may be terminated before the minimum threshold value T₁ is reached if a pre-determined condition is met, for example, when the rate of accumulating incremental votes from advancing in the ordered sequence stabilizes or when a maximum number of allowable defective pixels (sensing elements) (i.e., bad pixel candidates) is reached, in which case the image sensor may be declared unacceptable. In embodiments where the voting process is terminated based on a maximum number (by definition equal to K) of allowable defective pixels (sensing elements), the augmented bad pixel list may be configured as a fixed size data structure where the size is determined based on the maximum number of allowable defective pixels (sensing elements). Similar to the voting count table described above, the augmented bad pixel list may be implemented using a non-volatile memory or other suitable data repository.

In one or more embodiments of the invention, a pixel (sensing element) at location (y,x) may be classified by the voting module (403) using the simple gradient operator described with respect to FIG. 1 above. If it is classified as defective, a determination is made by the voting module (403) as to whether the pixel (sensing element) has been classified as defective by another classifier previously, in which case a corresponding entry may be found in the augment bad pixel list and the voting count may then be incremented in this entry by one or according to certain weighting scheme. If the pixel (sensing element) has never been classified as defective previously, a new entry may then be added in the augment bad pixel list. In one or more embodiments of the invention, the voting process is executed for every pixel (sensing element) of the image sensor; that is, it is repeatedly executed for W×H times, where H is the image height and W is the image width.

It is noted that the augmented bad pixel list (404) consists not only true positive bad pixels but also false alarm bad pixels. In one or more embodiments of the invention, the true positive bad pixels is separated from the false alarm ones based on a classification threshold T_{Q} at the process of bad pixel correction instead of at the process of bad pixel detection.

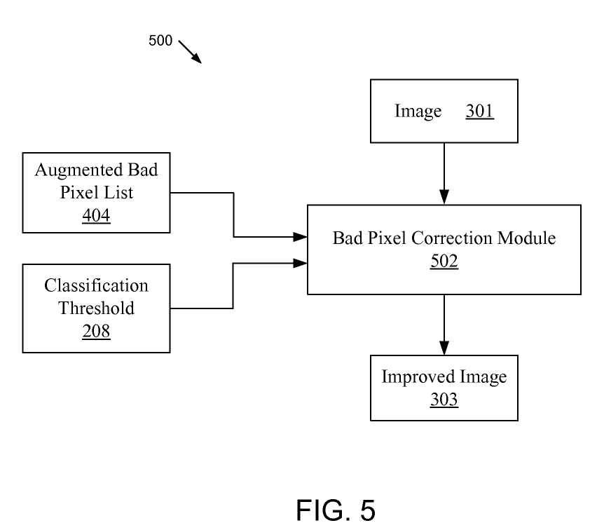

FIG. 5 shows a system block diagram of a system (500) for bad pixel correction according to aspects of the invention. Here, system (500) includes image bad pixel correction module (502) that receives image (301) (e.g., from the image sensor (201) of FIG. 2) to produce improved image (303) using the augmented bad pixel list (404) {U₁, U₂, . . . , U_{K}} and classification threshold (208). In one or more embodiments of the invention, a pixel at location (y,x) in the image (301) may be corrected using conventional method if it corresponds to any of {U₁, U₂, . . . , U_{K}} in the augmented bad pixels pixel list (404) and the voting count in the corresponding entry exceeds the classification threshold (208). The correction process may be performed for every pixel of the image (301); that is, it is repeatedly executed for W×H times, where H is the image height and W is the image width. At the end of bad pixel correction process, an improved bad-pixel-free image (303) is obtained.

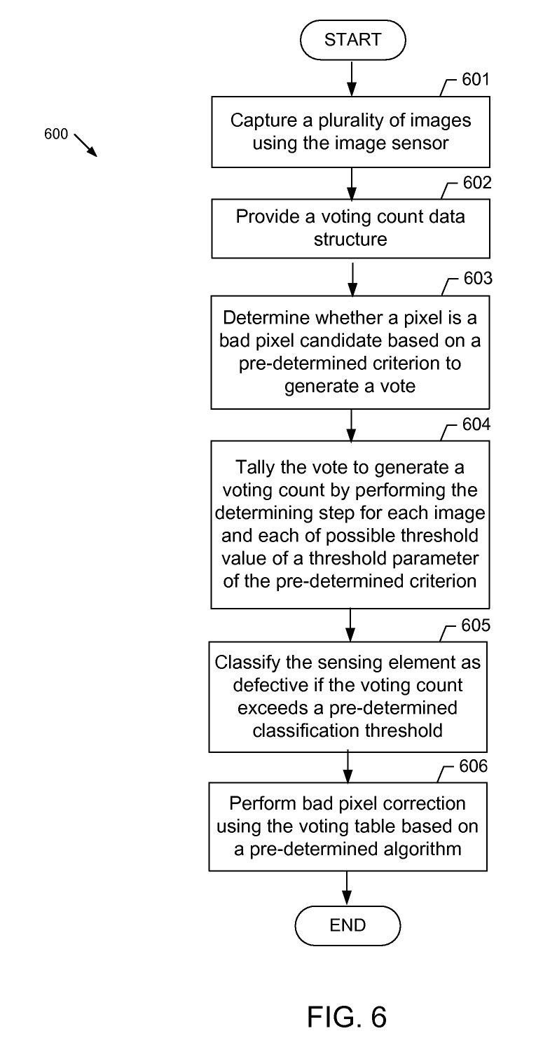

FIGS. 6 shows a flow chart of a method (600) according to aspects of the invention. The method may be practiced using system (200), (300), (400), or (500). Initially, a plurality of images (e.g., (202-1) through (202-N)) are captured using an image sensor (i.e., (201)) (step 601). In addition, a voting count data structure is provided (step 602), for example as a voting count table described with respect to FIG. 2 or as an augmented bad pixel list (404) described with respect to FIG. 4.

Given an image based on a pre-determined criterion (e.g., described with respect to FIG. 1), it is determined whether a pixel (e.g., at location (x, y)) in the image (thus a corresponding sensing element in the image sensor) is defective. A vote is then generated (e.g., as described with respect to voting module (203) or (403)) according to the determination to indicate the corresponding sensing element as a bad pixel candidate (step 603). The pre-determined criterion is associated with a threshold parameter, where the threshold parameter is set to a threshold value selected from one or more pre-determined threshold values (e.g., voting threshold (207)).

Continuing with the method (600), the vote is tallied to generate a voting count (e.g., (204)) by performing the determining step (step 602) with the threshold parameter set to different values (e.g., each of the one or more pre-determined threshold values (e.g., voting threshold (207))) for different image (e.g., each image of the plurality of images (e.g., (202-1) through (202-N))) (step 604). Accordingly, the sensing element (e.g., at location (x, y)) is classified as a bad pixel if the voting count (e.g., (204)) exceeds a pre-determined classification threshold (e.g., (208)) (step 605).

In one or more embodiments of the invention, the vote in step 602 is weighted based on the image according to a pre-determined weighting scheme based on an attribute (e.g., associated with the scene, luminance intensity, field of view, etc.) of the image. In one or more embodiments of the invention, the vote in step 602 is weighted based on the threshold value according to a pre-determined weighting scheme, for example favoring certain threshold values.

In one or more embodiments of the invention, the vote in step 602 is generated by comparing the pixel to a plurality of neighboring pixels to generate a difference, wherein the plurality of neighboring pixels are captured by a plurality of neighboring sensing elements selected from the plurality of sensing elements based on a pre-determined configuration (e.g., as describe with respect to FIG. 1) with respect to the sensing element and generating the vote of the pixel as defective if the difference exceeds the threshold parameter.

In one or more embodiments of the invention, the one or more pre-determined threshold values are set to exceed a pre-determined minimum threshold value selected to minimize a false positive rate of bad pixel classification.

Typically, the determining, tallying, and classifying is performed for each sensing element of the plurality of sensing elements. In one or more embodiments of the invention, a voting count table (e.g., described with respect to FIG. 2) may be provided in step 602 as the data structure with a plurality of entries corresponding to the plurality of sensing elements in the image sensor, where each of the plurality of sensing elements is associated with one entry of voting count table for storing a corresponding voting count. In one or more embodiments of the invention, an augmented bad pixel list may be provided in step 602 as the data structure with a plurality of entries corresponding to a portion of the plurality of sensing elements each corresponding to a non-zero voting count stored in a corresponding entry in the augmented bad pixel list.

Further continuing with the method (600), bad pixel correction may then be performed using the voting table or the augmented bad pixel list based on a pre-determined algorithm, such as a conventional correction method (step 606).

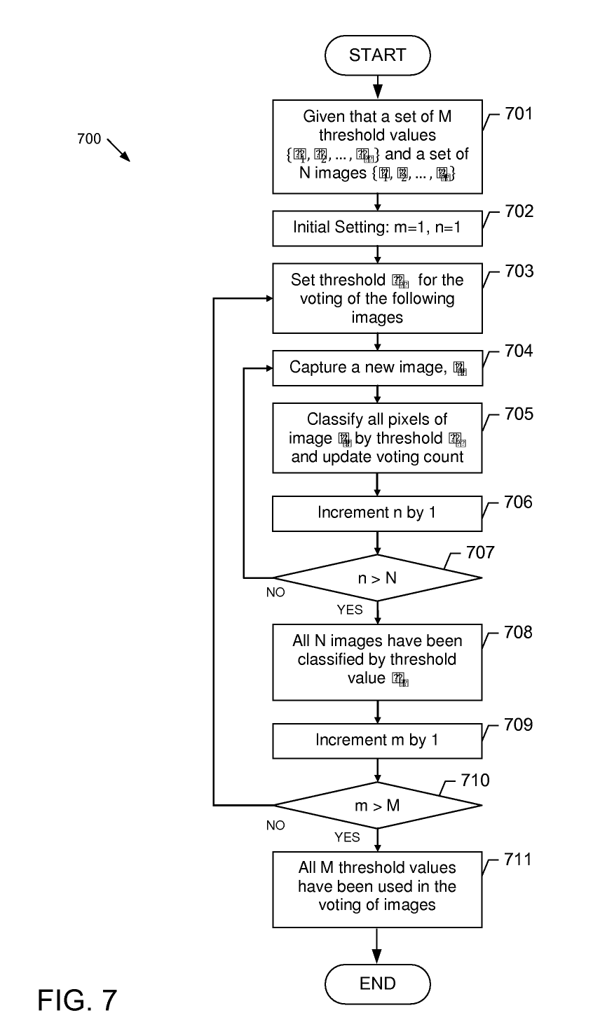

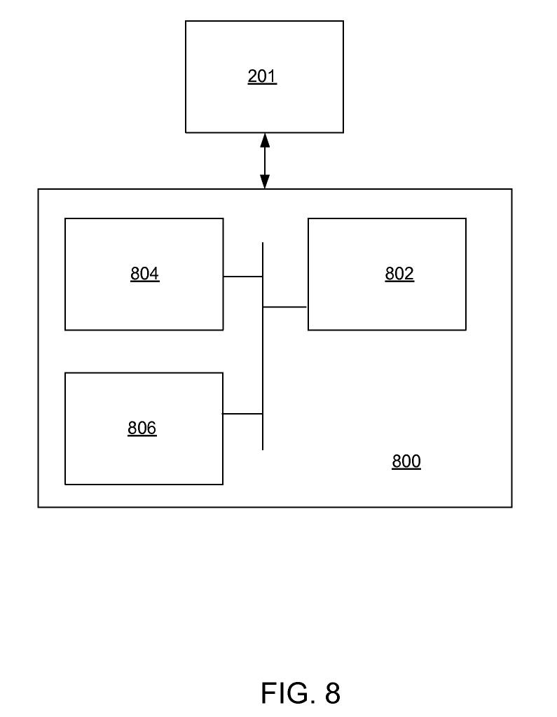

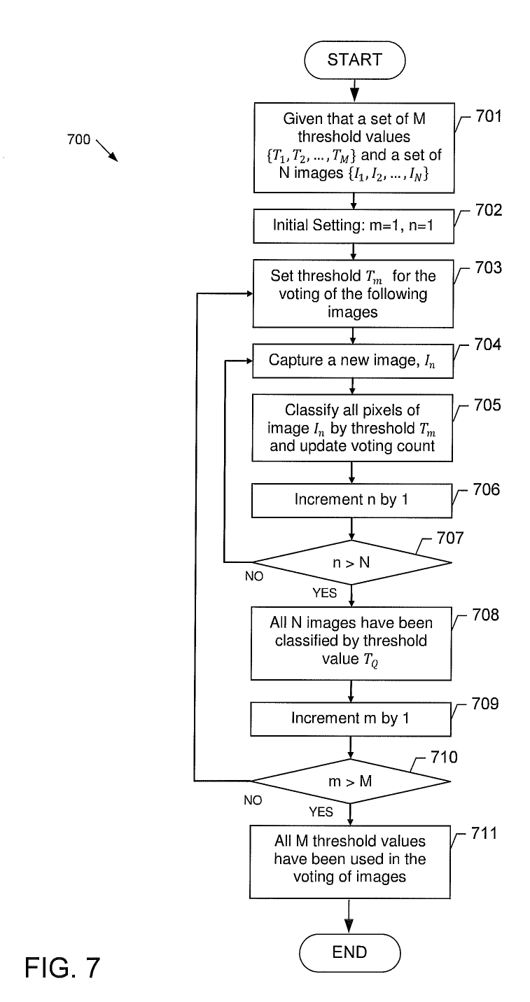

FIGS. 7 shows a flow chart of a method (700) according to aspects of the invention. The method may be practiced using system (200), (300), (400), or (500) to implement example details of steps 603-605 of FIG. 6 above.

In step 701, a set of voting threshold values {T₁, T₂, . . . , T_{M}} (e.g., (207)) is provided. A voting threshold Tₘ is then obtain from the set of voting threshold values for the simple gradient operator (e.g., described with respect to FIG. 1), where 1≦m≦M (steps 702-703). In addition, an image Iₙ is captured as the input to the simple gradient operator, where 1≦n≦N (step 704). All pixels of image Iₙ are classified by voting threshold and corresponding voting counts are updated in step 705 where the combination of image Iₙ and voting threshold is considered a member classifier of a committee of classifiers.

Continuing with the method (700), another image is captured by incrementing n (step 706) and repeating step 705, until all N images are captured and classified (step 707). In one or more embodiments of the invention using the method (700), these N images are not saved in image buffers since the classification is done image by image on the fly as each of the N captured images {I₁, I₂, . . . , I_{N}} is captured. Subsequently, another voting threshold Tₘ₊₁ is selected by incrementing m (step 709) and repeating steps 703-708 with another set of N captured images {I₁′, I₂′, . . . , I_{N}′} until all M voting thresholds have been applied (steps 710-711). Accordingly, the voting counts of all pixels {V₁, V₂, . . . , V_{L}} may be collected. In method (700), total of M×N images are captured and processed. In a modification of the method (700), the iterations of step 705 may be iterated over all of M threshold values for each captured image Iₙ currently with capturing the image In before being iterated over the N images. In such embodiments, only N images are captured and processed. Other combination schemes may also be formulated to form a committee of classifiers by combining different images and different voting thresholds as member classifiers.

Portions or all of the invention (e.g., any of the voting module (203), voting module (403), classification module (205), bad pixel correction module (302), and bad pixel correction module (502)) may be implemented based on various scheme, such as hardware circuit, processor executing imbedded micro-code or firmware, software, or combinations thereof. For example, the invention may be implemented on virtually any type of computing resource regardless of the platform being used. For example, as shown in FIG. 8, a computing system (800) includes a processor (802), associated memory (804), a storage device (806), and numerous other elements and functionalities typical of today's computing system (not shown). The computing system (400) may also include input means, such as image sensor (201), a keyboard/mouse (not shown), and output means, such as a display monitor (not shown). Those skilled in the art will appreciate that these input and output means may take other forms.

It will be understood from the foregoing description that various modifications and changes may be made in the preferred and alternative embodiments of the present invention without departing from its true spirit. This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

What is claimed is:

1. A method for bad pixel classification for an image sensor having a plurality of sensing elements, comprising:
capturing a plurality of images using the image sensor;
determining based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value;
tallying the vote to generate a voting count by performing iterations of the determining step using different images of the plurality of images and different threshold values of the one or more pre-determined threshold values; and
classifying the sensing element as a bad pixel if the voting count exceeds a pre-determined classification threshold.

2. The method of claim 1, wherein each iteration of the determining step using one image of the plurality of images are performed concurrently with capturing the one image.

3. The method of claim 1, wherein the vote is weighted based on the image according to a pre-determined weighting scheme.

4. The method of claim 1, wherein the vote is weighted based on the threshold value according to a pre-determined weighting scheme.

5. The method of claim 1, wherein determining based on the pre-determined criterion whether the sensing element is defective to generate the vote comprises:
comparing a pixel in the image captured by the sensing element to a plurality of neighboring pixels in the image to generate a difference, wherein the plurality of neighboring pixels are captured by a plurality of neighboring sensing elements of the sensing element; and
generating the vote of the sensing element as defective if the difference exceeds the threshold parameter.

6. The method of claim 1,
wherein the one or more pre-determined threshold values are set to exceed a pre-determined minimum threshold value, and
wherein the pre-determined minimum threshold value is selected to minimize a false positive rate of bad pixel classification.

7. The method of claim 1, the method further comprising:
performing the determining, tallying, and classifying for each sensing element of the plurality of sensing elements;
providing a voting count table having a plurality of entries corresponding to the plurality of sensing elements, wherein each of the plurality of sensing elements is associated with one entry of the plurality of entries for storing a corresponding voting count; and
performing bad pixel correction using the voting table based on a pre-determined algorithm.

8. The method of claim 1, the method further comprising:
performing the determining, tallying, and classifying for each sensing element of the plurality of sensing elements;
providing an augmented bad pixel list having a plurality of entries corresponding to a portion of the plurality of sensing elements each corresponding to a non-zero voting count stored in a corresponding entry in the plurality of entries; and
performing bad pixel correction using the augmented bad pixel list based on a pre-determined algorithm.

9. A device for performing bad pixel classification for an image sensor having a plurality of sensing elements, comprising:
a voting module configured to:
receive a plurality of images captured using the image sensor;
determine based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value;
tally the vote to generate a voting count by performing iterations of the determining step using different images of the plurality of images and different threshold values of the one or more pre-determined threshold values; and
classify the sensing element as a bad pixel if the voting count exceeds a pre-determined classification threshold; and
a classification module operatively coupled to the voting module and configured to:
compare the voting count to a pre-determined classification threshold; and
classify the sensing element as a bad pixel if the voting count exceeds the pre-determined classification threshold.
classifying the sensing element as a bad pixel if the voting count exceeds a pre-determined classification threshold.

10. The device of claim 9, wherein each iteration of the determining step using one image of the plurality of images are performed concurrently with capturing the one image.

11. The device of claim 9, wherein the vote is weighted based on the image according to a pre-determined weighting scheme.

12. The device of claim 9, wherein the vote is weighted based on the threshold value according to a pre-determined weighting scheme.

13. The device of claim 9, wherein determining based on the pre-determined criterion whether a sensing element is defective to generate the vote comprises:
comparing a pixel in the image captured by the sensing element to a plurality of neighboring pixels in the image to generate a difference, wherein the plurality of neighboring pixels are captured by a plurality of neighboring sensing elements of the sensing element; and
generating the vote of the sensing element as defective if the difference exceeds a pre-determined threshold.

14. The device of claim 9,
wherein the one or more pre-determined threshold values exceed a pre-determined minimum threshold value, and
wherein the pre-determined minimum threshold value is selected to minimize a false positive rate of bad pixel classification.

15. The device of claim 9, wherein the voting module is further configured to:
perform the determining, tallying, and classifying for each sensing element of the plurality of sensing elements;
manage a voting count table having a plurality of entries corresponding to the plurality of sensing elements, wherein each of the plurality of sensing elements is associated with one entry of the plurality of entries for storing a corresponding voting count; and
store the voting count in an entry of the plurality of entries corresponding to the sensing element,
the device further comprising:
a bad pixel correction module configured to perform bad pixel correction using the voting table based on a pre-determined algorithm.

16. The device of claim 9, wherein the voting module is further configured to:
perform the determining, tallying, and classifying for each sensing element of the plurality of sensing elements;
manage an augmented bad pixel list having a plurality of entries corresponding to a portion of the plurality of sensing elements each corresponding to a non-zero voting count stored in a corresponding entry in the plurality of entries; and
store the voting count in an entry of the plurality of entries corresponding to the sensing element,
the device further comprising:
a bad pixel correction module configured to perform bad pixel correction using the augmented bad pixel list based on a pre-determined algorithm.

17. A system, comprising:
an image sensor having a plurality of sensing elements;
a voting module configured to:
receive a plurality of images captured using the image sensor;
determine based on a pre-determined criterion, using an image of the plurality of images and a threshold value selected from one or more pre-determined threshold values, whether a sensing element in the image sensor is defective to generate a vote, wherein a threshold parameter associated with the pre-determined criterion is set to the threshold value;
tally the vote to generate a voting count by performing iterations of the determining step using different images of the plurality of images and different threshold values of the one or more pre-determined threshold values; and
classify the sensing element as a bad pixel if the voting count exceeds a pre-determined classification threshold; and
a classification module operatively coupled to the voting module and configured to:
compare the voting count to a pre-determined classification threshold; and
classify the sensing element as defective if the voting count exceeds the pre-determined classification threshold.

18. The system of claim 17, wherein each iteration of the determining step using one image of the plurality of images are performed concurrently with capturing the one image.

19. The system of claim 17, wherein the vote is weighted based on the image according to a pre-determined weighting scheme.

20. The system of claim 17, wherein the vote is weighted based on the threshold value according to a pre-determined weighting scheme.

21. The system of claim 17, wherein determining based on the pre-determined criterion whether the sensing element is defective to generate the vote comprises:
comparing a pixel in the image captured by the sensing element to a plurality of neighboring pixels in the image to generate a difference, wherein the plurality of neighboring pixels are captured by a plurality of neighboring sensing elements of the sensing element; and
generating the vote of the sensing element as defective if the difference exceeds a pre-determined threshold.

22. The system of claim 17,
wherein the one or more pre-determined threshold values are set to exceed a pre-determined minimum threshold value, and
wherein the pre-determined minimum threshold value is selected to minimize a false positive rate of bad pixel classification.

23. The system of claim 17, wherein the voting module is further configured to:
perform the determining, tallying, and classifying for each sensing element of the plurality of sensing elements;
manage a voting count table having a plurality of entries corresponding to the plurality of sensing elements, wherein each of the plurality of sensing elements is associated with one entry of the plurality of entries for storing a corresponding voting count; and
store the voting count in an entry of the plurality of entries corresponding to the sensing element,
the system further comprising:
memory for storing the voting count table; and
a bad pixel correction module configured to perform bad pixel correction using the voting table based on a pre-determined algorithm.

24. The system of claim 17, wherein the voting module is further configured to:
perform the determining, tallying, and classifying for each sensing element of the plurality of sensing elements;
manage an augmented bad pixel list having a plurality of entries corresponding to a portion of the plurality of sensing elements each corresponding to a non-zero voting count stored in a corresponding entry in the plurality of entries; and
store the voting count in an entry of the plurality of entries corresponding to the sensing element,
the system further comprising:
a bad pixel correction module configured to perform bad pixel correction using the augmented bad pixel list based on a pre-determined algorithm.

25. A computer readable medium, embodying instructions executable by the computer to perform bad pixel classification for an image sensor having a plurality of sensing elements, the instructions comprising functionality for:
capturing a plurality of images using the image sensor;
determining, using an image of the plurality of images and a threshold value selected from one or more pre-determined threshold values, whether a sensing element in the image sensor is defective, based on a pre-determined criterion, to generate a vote, wherein a threshold parameter associated with the pre-determined criterion is set to the threshold value;
tallying the vote to generate a voting count by performing iterations of the determining step using different images of the plurality of images and different threshold values of the one or more pre-determined threshold values; and
classifying the sensing element as a bad pixel if the voting count exceeds a pre-determined classification threshold.

26. The computer readable medium of claim 25, wherein each iteration of the determining step using one image of the plurality of images are performed concurrently with capturing the one image.

27. The computer readable medium of claim 25, wherein the vote is weighted based on the image according to a pre-determined weighting scheme.

28. The computer readable medium of claim 25, wherein the vote is weighted based on the threshold value according to a pre-determined weighting scheme.

29. The computer readable medium of claim 25, wherein determining based on the pre-determined criterion the sensing element is defective to generate the vote comprises:
comparing a pixel in the image captured by the sensing element to a plurality of neighboring pixels in the image to generate a difference, wherein the plurality of neighboring pixels are captured by a plurality of neighboring sensing elements of the sensing element; and
generating the vote of the sensing element as defective if the difference exceeds the threshold parameter.

30. The computer readable medium of claim 25,
wherein the one or more pre-determined threshold values are set to exceed a pre-determined minimum threshold value, and
wherein the pre-determined minimum threshold value is selected to minimize a false positive rate of bad pixel classification.

31. The computer readable medium of claim 25, the instructions further comprising functionality for:
performing the determining, tallying, and classifying for each sensing element of the plurality of sensing elements;
providing a voting count table having a plurality of entries corresponding to the plurality of sensing elements, wherein each of the plurality of sensing elements is associated with one entry of the plurality of entries for storing a corresponding voting count; and
performing bad pixel correction using the voting table based on a pre-determined algorithm.

32. The computer readable medium of claim 25, the instructions further comprising functionality for:
performing the determining, tallying, and classifying for each sensing element of the plurality of sensing elements;
providing an augmented bad pixel list having a plurality of entries corresponding to a portion of the plurality of sensing elements each corresponding to a non-zero voting count stored in a corresponding entry in the plurality of entries; and
performing bad pixel correction using the augmented bad pixel list based on a pre-determined algorithm.
